(19) United States
(12) Patent Application Publication
(10) Pub. No.: US 2025/0375911 A1
(43) Pub. Date: Dec. 11, 2025

(54) MANUAL SADDLE PEELING DEVICE FOR MACHINING OF SURFACES OF PIPES

(71) Applicant: PF-Schweisstechnologie GmbH, Alsfeld (DE)

(72) Inventor: Achim Spychalski-Merle, Alsfeld (DE)

(21) Appl. No.: 19/225,793

(22) Filed: Jun. 2, 2025

(30) Foreign Application Priority Data
Jun. 7, 2024 (EP) 24180804.7

(51) Int. Cl. B26D 3/28

(52) U.S. Cl. CPC B26D 3/282

(57) ABSTRACT

A manually operated saddle peeling device for machining an outer surface of a tubular body, comprises a supporting unit and a guiding unit provided on an underside of the supporting unit and configured to guide the supporting unit in a peeling direction at a defined distance from the surface of the tubular body to be machined. The device further comprises a peeling unit provided on an underside of the supporting unit opposite the surface of the tubular body to be machined, comprising at least one stationary peeling blade which is configured to contact the surface of the tubular body to be machined and thereby remove material from the surface of the tubular body and a handle unit provided to the side of the supporting unit and thus generally parallel to the peeling direction and configured to enable manual guidance of the saddle peeling device over the outer surface of the tubular body at least in portions.

### BACKGROUND

### TECHNICAL FIELD

The disclosure relates to a saddle peeling device as used for machining an outer surface of pipes, in particular in the processing of fluid-conducting plastic pipes, such as polyethylene (PE) pipes.

### DESCRIPTION OF THE RELATED ART

Peeling devices are used for the surface treatment of plastic pipes during installation work. The pipes can become deformed as a result of compressive forces acting on them, for example if they are wound onto roll supports. An oxide layer can also form on the surface of plastic pipes, particularly after prolonged exposure to the weather (especially UV exposure) during downtimes or storage on construction sites, but also as a result of ageing. The deformation and/or the oxide layer is disadvantageous in the fluid-tight connection of pipe sections by means of electrofusion welding or heating element saddle welding, as it prevents uniform melting of the surface and the formation of a homogeneous weld seam during cooling. However, a fluid-tight connection is absolutely essential, especially for pipes carrying water or gas, due to the risk of subsequent leakage and thus the escape of flammable gases. Peeling devices can be used to remove the oxidized surface of the pipe in the section of the pipe joints to be created in order to prepare the surface for the welding process.

The peeling devices known in practice require the pipe surface to be fully exposed, as these devices are attached to the pipe over the entire pipe circumference. Particularly in the area of saddle connections, such as the creation of a branch on an already laid pipe (e.g., in the sense of a T-joint), this leads to considerable effort, especially as only a relatively small surface section is to be machined in the circumferential direction.

In other cases, full exposure of the pipe surface is impossible due to the limited space available. The known peeling devices can often only be used at one end of a pipe, as they require a surface that is perpendicular to the pipe axis to guide the peeling device. Furthermore, the known peeling devices often use an electric actuator to drive the peeling blade. This is particularly problematic when peeling devices are used in potentially explosive atmospheres, as only explosion-protection-verified electric actuators are permitted here. This also leads to increased costs. Furthermore, the use of electrically driven, rotating peeling knives leads to the formation of a large number of small chips. These can only be collected with considerable effort and therefore represent a potential burden on the environment if not collected properly. The use of hand scrapers leads to an uneven surface due to the varying peeling depth with completely free guidance of the scrapers. The results achieved in preparing the surfaces for a welding process are not satisfactory in terms of quality, particularly with regard to gas-conducting pipes.

The solutions available are therefore inefficient or of unsatisfactory quality in terms of the capital to be invested and represent a potential burden on the environment.

### BRIEF SUMMARY

It is the task of the present disclosure to provide a saddle peeling device which enables manual peeling of a section of a pipe surface in preparation for a saddle connection without having to expose the full circumference of the pipe and without having to fulfill additional requirements in the context of explosion protection. The present disclosure thus makes it possible to prepare the pipe surface for subsequent welding operations in an efficient and environmentally friendly manner.

The present disclosure relates to a manually operated saddle peeling device for machining an outer surface of a tubular body. The manually operated saddle peeling device or hand guided saddle peeling device comprises a supporting unit to which a guiding unit, a peeling device and a handle unit are attached. The guiding unit is provided on the underside of the supporting unit and is configured to guide the supporting unit at a defined distance from the surface of the tubular body to be machined. The peeling device is provided on the underside of the supporting unit, comprises at least one peeling blade which is configured to contact the surface of the tube to be machined, thereby removing material from the surface of the tube. The handle unit is provided to the side of the supporting unit and is configured to enable manual guidance of the saddle peeling device over the outer surface of the pipe, at least in sections.

By using the manually operated saddle peeling device, it is not necessary to expose the tubular body or pipe or tube over the entire circumference, since the saddle peeling device according to the disclosure only requires the section of the pipe surface to be machined to be exposed. Furthermore, the saddle peeling device does not comprise any electrical components for guiding the device on the pipe or for moving the peeling blade relative to the carrier unit, which require separate certification in accordance with the explosion protection specifications. This means that the saddle peeling device can also be used in potentially explosive atmospheres. Furthermore, the chips produced by manual processing are larger than those produced by a fast rotating peeling blade. Larger chips are easier to detect and can be collected more easily. Environmental pollution with microplastics resulting from the machining of the surface can be prevented. Furthermore, the guiding unit allows precise adjustment and guidance of the peeling blade in relation to the surface to be processed. The peeling depth can be precisely adjusted and is not subject to the fluctuations resulting from the use of a hand scraper.

In an advantageous embodiment, the at least one handle unit can be arranged relative to the supporting unit in such a way that it enables manual guidance of the saddle peeling device perpendicular to the peeling direction of the peeling blade. The saddle peeling device can be guided parallel to the surface of the tube to be machined. In a further advantageous embodiment, the handle unit may comprise a handle. The supporting unit may include a cover configured to provide a second point of force application for a user of the peeling device, such that one hand of the user engages the handle and another engages the cover of the supporting unit. A surface of the handle unit and/or the cover may be provided with a rubberized surface to increase the friction between an operator’s hand and the handle unit.

In an advantageous embodiment, the handle unit may be arranged relative to the supporting unit so as to allow manual guidance of the device parallel to the peeling direction of the peeling blade. In other words a longitudinal axis of the handle unit may be arranged perpendicular to the peeling direction. In a further advantageous embodiment, the handle unit may comprise a handle. The supporting unit may include a cover configured to provide a second point of force application for a user of the peeling device, such that one hand of the user engages the handle and another engages the cover of the supporting unit. A surface of the handle unit and/or the cover may be provided with a rubberized surface to increase the friction between an operator’s hand and the handle unit.

In an advantageous embodiment, the handle unit may include two handles which may be attached to opposite side surfaces of the supporting unit. The side surfaces extend parallel to the peeling direction. The handles may be separately detachably connected to the supporting unit to enable quick replacement of the handles.

In an advantageous embodiment, the two handles of the handle unit can be designed as hand grips. The hand grips can have a round cross-section. The hand grips may have an at least partially round cross-section. The hand grips may have a surface which increases the friction between the respective hand grips and the hand of a user. The respective hand grips may further have an ergonomic shape which makes it easier to enclose and hold the hand grips with the hand.

In an advantageous embodiment, the at least one handle unit may be spaced apart from a vertical central longitudinal axis of the supporting unit, and the handle unit may be spaced apart from the vertical central longitudinal axis in or against the peeling direction. The handles may be arranged coaxially on both sides of the supporting unit. In such instances, the coaxial longitudinal axis formed by the two handles may be spaced from the vertical longitudinal center axis of the supporting unit in or against the peeling direction. Further, the offset of the handle unit with respect to the vertical longitudinal center axis of the supporting unit may be oriented on the position of the peeling unit with respect to the vertical longitudinal center axis of the supporting unit. Furthermore, the offset of the handle unit relative to the vertical central longitudinal axis of the supporting unit can be oriented on the position of the guiding unit relative to the vertical central longitudinal axis of the supporting unit. The mount point of the at least one handle unit, defined by its longitudinal axis may be in peeling direction offset from or at the contact point at which the peeling blade contacts the surface of the tubular body to be machined

In an advantageous embodiment, the at least one peeling blade of the peeling unit may be releasably coupled to the peeling unit. The reversibly detachable coupling can be established via a screw connection or a clamp connection or a latching mechanism of the at least one peeling blade in a corresponding device or by a combination of different types of connection.

In an advantageous embodiment, the vertical distance between the outer surface of the tube and the at least one peeling blade of the peeling unit may be adjustable to vary a peeling depth of the at least one peeling blade. In other words, the radial distance in terms of a coordinate system of the tube between the surface of the tube to be machined and the at least one peeling blade of the peeling unit may be adjustable. Furthermore, an indicator on the peeling unit and/or the guiding unit can provide the operator with feedback on the set peeling depth. The peeling depth can be set using a screw mechanism. The peeling depth can be set using a locking mechanism. The setting can be infinitely variable or in relation to previously defined peeling depths.

In an advantageous embodiment, the angle between an axis which is perpendicular to the cutting edge or blade edge of the at least one peeling blade of the peeling unit and an axis which is parallel to the peeling direction can be adjustable. This allows an inclined position of the cutting edge relative to the peeling direction to be set.

In an advantageous embodiment, the angle between an axis which is perpendicular to the at least one peeling blade of the peeling unit and an axis which is perpendicular to a surface of the tubular body to be machined can be adjustable. The adjustment can be made via a holding device for the peeling blade. The adjustment can be made using a screw on the holder for the peeling blade. The adjustment can be made via a set of peeling blade holders, each of which can differ in the angle between an axis that is perpendicular to the at least one peeling blade of the peeling unit and an axis that is perpendicular to a surface of the tubular body to be machined.

In an advantageous embodiment, a force can be applied to the at least one peeling blade by means of a spring in a direction perpendicular to the surface of the tube to be machined. The spring can be configured as a bending spring or as a torsion spring or as a helical spring or as a disk spring or as a combination of different spring elements. The spring can also be configured as an integral part of the peeling unit, so that when a force is applied in a direction perpendicular to the be machined surface of the tube, it deforms elastically in this direction and thus causes a spring effect in relation to the peeling blade. The spring force can be transferred to the peeling blade via a lever.

In an advantageous embodiment, a force can be applied to the at least one peeling blade by means of a spring in a direction parallel to the surface of the tubular body to be machined. The spring can be designed as a bending spring or as a torsion spring or as a helical spring or as a disk spring or as a combination of different spring elements. The spring force can be transferred to the peeling blade via a lever.

In an advantageous embodiment, the force applied by the spring to the at least one peeling blade can be adjustable. The spring force can be adjusted by changing between different springs, whereby the time required for the change can be shortened by simplified accessibility of the spring by a user. The spring force can be adjusted using an adjustment element that is mounted in such a way that it is accessible from the outside of the saddle peeling device, that is that the adjusting element can be adjusted without removing any parts of the saddle peeling device. The spring force can be adjusted using a rotary control. The spring force can be adjusted by using different peeling units containing springs with different spring constants or different preloads.

In an advantageous embodiment, the guiding unit may comprise two rollers whose axes of rotation may be arranged in parallel. The axes of rotation of the rollers of the guiding unit may be laterally offset with respect to the peeling unit. The axes of rotation of the peeling unit can be arranged in front of and behind the peeling unit in the direction of peeling. The axes of rotation can be arranged on the same side in relation to the peeling unit. The axes of rotation of the guiding unit can be arranged in relation to the supporting unit in such a way that rollers with different diameters can rotate around the axes of rotation without contacting the supporting unit. The rollers can be arranged in front of and behind the supporting unit in the peeling direction to allow a larger roller diameter. The rollers can be arranged on different sides in relation to the peeling unit. The rollers may extend over a substantial portion of the supporting unit in a direction perpendicular to the peeling direction. The rollers may have a running surface which increases the friction between the surface of the tube to be machined and the guiding unit.

In an advantageous embodiment, the guiding unit can comprise two rollers whose axes of rotation can be arranged coaxially. Further support of the guiding unit on the surface of a tube to be machined can be provided by at least one skid. The guiding unit can be further supported by a track. This track may be designed as a rubberized track and can be guided over a plurality of small rollers in order to increase the friction between the guiding unit and a surface of a tube to be machined.

In an advantageous embodiment, the guiding unit may comprise four rollers.

In an advantageous embodiment, the axes of rotation of at least two rollers can be coaxially aligned. The coaxially arranged rollers can each be arranged on one side of the peeling unit. The coaxially arranged rollers may be arranged in front of or behind the peeling unit in the peeling direction. The coaxially arranged rollers can be arranged in front of or behind the connection point of the handle unit with the supporting unit in the peeling direction.

In an advantageous embodiment, the four rollers can be arranged on two parallel axes of rotation. The distance between the parallel axes of rotation can be adjustable.

In an advantageous embodiment, the peeling unit can be mounted between the two parallel axes of rotation of the guiding unit such that the contact point of the peeling blade and the surface of the tubular body to be machined is at or offset against the peeling direction from an intersection of an axis in radial direction defined by the center of the tubular body and a midpoint defined between the two axes of rotation and the surface of the tubular body to be machined.

In an advantageous embodiment, the rollers of the guiding unit can be interchangeable. The rollers can be attached to the respective axles by means of a detachable connection. The rollers can be attached to the respective axles with screws. The rollers can be attached to the respective axles with retaining rings. The rollers can be attached to the respective axles with locking pins. The axles can be attached to the guiding unit by means of a detachable connection. This allows the axle and the rollers attached to it to be replaced quickly.

In an advantageous embodiment, the at least one handle unit can be detachably coupled to the supporting unit. The at least one handle unit can be coupled to the supporting unit by means of a plug-in connection. The at least one handle unit can be coupled to the supporting unit by means of a screw coupling. The at least one handle unit can be coupled to the supporting unit by means of a snap-in connection. The coupling elements between the supporting unit and the at least one handle unit can be arranged in such a way that accidental loosening of the fastening elements can be avoided.

In an advantageous embodiment, the peeling unit can be detachably coupled to the supporting unit. The coupling can be established via pins, which can be secured against unintentional loosening. The coupling can be established by means of a screw connection. The coupling can be established via a secured plug-in connection. The coupling can be established using at least one retaining ring. The connection can be located under a cover inside the supporting unit to prevent unintentional loosening of the connection.

In an advantageous embodiment, the coupling between the guiding unit and the supporting unit may comprise at least one spring. The at least one spring may be arranged in the guiding unit. The at least one spring may be arranged in the supporting unit.

In an advantageous embodiment, the at least one spring mounted in the connection between the supporting unit and the guiding unit may be adjustable. The adjustment can be made via a unit that can be accessible from the outside. The adjustment can be made via a unit which cannot be accessible from the outside.

In an advantageous embodiment, a method of machining a surface of a tubular body may include exposing a surface of the tubular body to be machined, adjusting the cutting depth of the blade on a manually operated saddle peeling device, and machining the surface of the pipe to be machined by manually guiding the saddle peeling device over the surface to be machined.

### BRIEF DESCRIPTION OF THE SEVERAL VIEWS OF THE DRAWINGS

FIG. 1 is a perspective view of a manually operated saddle peeling device from below according to a first embodiment.

FIG. 2 is a perspective oblique side view of the manually operated saddle peeling device from the front according to the first embodiment.

FIG. 3 is a perspective view from above of a manually operated saddle peeling device placed on a tube to be machined according to a second embodiment.

FIG. 4 is a side view of a manually operated saddle peeling device according to the second embodiment, placed on an outer surface of a pipe to be machined.

### DETAILED DESCRIPTION

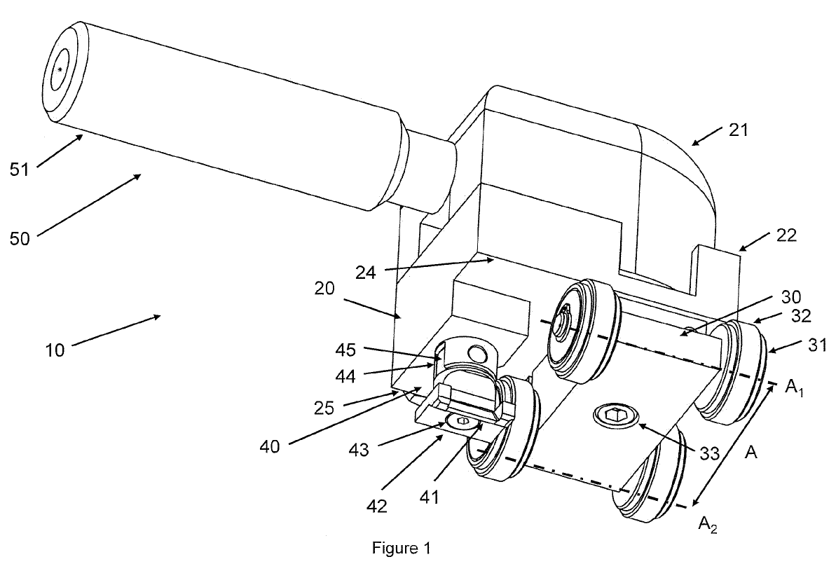

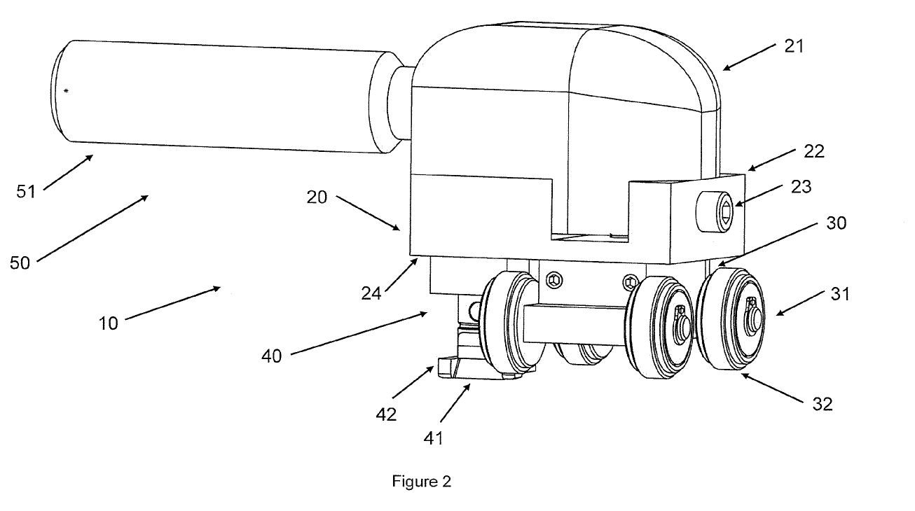

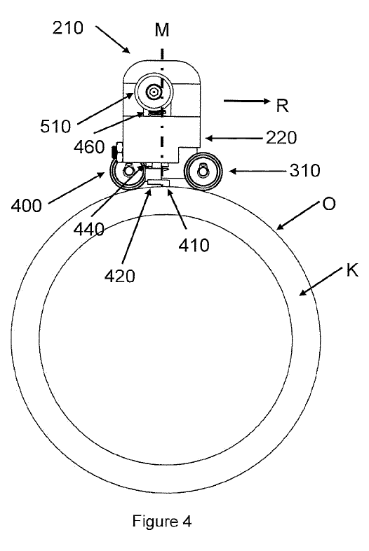

FIGS. 1 and 2 show a first embodiment example of the manually operated saddle peeling device 10 for machining an outer surface of a tubular body. The saddle peeling device 10 comprises a supporting unit 20 on the underside of which, i.e., on the side facing a surface of the tubular body K to be machined when the device 10 is placed on a tubular body K to be machined, a guiding unit 30 and a peeling unit 40 are attached. A handle unit 50 is provided to a side of the supporting unit 10 extending at least approximately parallel to a peeling direction R (see FIG. 4), i.e., to a side extending parallel to the normal vector of the surface O of the tube K to be machined.

The supporting unit 20 comprises a base unit 22 and a cover 21 detachably coupled to the base unit 22. As can be seen in FIG. 2, the cover 21 is coupled to the base unit 22 by means of a screw connection 23. The cover 21 is partially enclosed in the lower section by the base unit 22, so that a form-fit connection is provided between the cover 21 and the base unit 22.

In the embodiment shown, the guiding unit 30 comprises four rollers 31 which are arranged on two parallel axes A₁, A₂ at a distance A from each other. The guiding unit 30 enables the saddle peeling device 10 to be guided at a defined vertical distance, or at a distance perpendicular to the central longitudinal axis of the tube K to be machined, to the surface of the tube. In other words, the guiding unit enables the saddle peeling device 10 to be guided at a defined distance in a radial direction from the surface O of the tube K to be machined. The guiding unit 30 is sufficiently rigid so that a force applied by an operator of the saddle peeling device 10 does not cause the guiding unit 30 to bend between the two parallel axes A₁, A₂. The parallel axes A₁, A₂ are arranged in front of the front edge 24 of the supporting unit 20 (axis A₁) and behind the rear edge 25 of the supporting unit 20 (axis A₂) in the peeling direction R, so that the guiding unit 30 partially extends beyond the supporting unit 20 in the peeling direction. The vertical distance between the parallel axes A₁, A₂ and the supporting unit 20 is selected so that the rollers 31 attached in each case can rotate freely without coming into contact with the supporting unit 20 when the saddle peeling device 10 is used. As can be seen in FIG. 1, the guiding unit 30 is coupled to the underside of the supporting unit 20 by means of a screw connection 33. This allows easy and quick replacement of the guiding unit 30, for example when machining tubes with different diameters, for disassembly for transportation or for maintenance of the guiding unit. The rollers 31 are provided with a running surface 32, which prevents them from slipping on the surface of the tube being machined. The rollers 31 are fixed to the respective axes A₁, A₂ by means of snap rings. This means that the rollers 31 can be replaced with rollers of a different diameter and/or rollers with different running surfaces 32 with little effort.

The peeling unit 40 is coupled to an underside of the supporting unit 20. In the embodiment example shown, the peeling unit 40 is offset laterally relative to the guiding unit 30 in the direction of the handle unit 50. The position of the guiding unit 30 and the peeling unit 40 with regard to the support unit 20 is selected such, that the contact point of the cutting edge of the peeling blade 41 and the surface O of the pipe K to be machined is located at or in peeling direction R slightly behind the apex of the surface O of the pipe K to be machined located in radial direction at a midpoint between the two axis A1, A₂. The peeling unit 40 extends from the underside of the supporting unit 20 in the direction of the surface of the pipe to be machined. A peeling blade 41, which is received in a peeling blade holder 42, is attached to the lower section of the peeling unit 40. The peeling blade holder 42 is detachably connected to a peeling blade guide 45 via a screw connection 43. This allows the peeling blade 41 to be replaced quickly. The peeling blade holder 42 comprises a left and a right side sliding block. The sliding blocks is configured to slide or to contact the surface O of a pipe K to be machined with its lower surface. The peeling depth is defined by the inclination of the peeling blade 41 with respect to the peeling direction or the lower sliding surface of the sliding blocks. The peeling blade 41 comprises a section inclined relative to the surface of the tube K to be machined. This section deflects chips that are lifted from the surface during machining upwards, making it easier for them to tear away from the surface of the tube K and to be conveyed away from the peeling blade 41 by the movement of the saddle peeling device 10. The peeling blade guide 45 is substantially designed as a cylinder but comprises a flat surface. The flat surface of the peeling blade guide 45 is directed in a direction opposite to the peeling direction R. A grub screw of the back side of the base unit 22 is used to prevent the peeling blade guide from rotating. The grub screw is secured against loosening by a screw nut (see FIG. 4). The peeling blade guide 45is accommodated in an adapter 44, which is connected to the base unit 22. By means of a corresponding fit, a play-free connection can thus be achieved between the adapter 44 and the peeling blade guide 45 and thus between the peeling unit 40 and the supporting unit 20. At the same time, a corresponding fit allows vertical adjustment of the peeling blade 41 relative to the surface to be machined. A vertical spring is arranged inside the peeling unit 40. The spring acts on the peeling blade guide 45 with a spring force. The peeling blade 41 is pressed onto the surface of the tube K to be machined by the spring force acting on it. A pivotable suspension connecting the spring to the peeling blade guide 45 ensure, that the peeling blade 41 is guided parallel to the surface O of the tubular body K to be machined. An indicator on the peeling unit 40 shows the set peeling depth.

A handle unit 50 is attached to a side surface of the supporting unit 20. In the embodiment shown, the handle unit 50 comprises a round handle 51 which enables the saddle peeling device 10 to be guided over a surface of a tube K to be machined or processed. The attachment point of the handle unit 50 is offset in opposite direction to the peeling direction relative to a vertical central axis of the supporting unit 20, which extends perpendicular to the longitudinal axis of the handle unit 50 and parallel to a normal vector of a plane extending through the two axes of rotation A₁, A₂ of the guiding unit 30. Furthermore, the attachment point of the handle unit is offset against the peeling direction from the contact point of the peeling blade and the surface of the pipe to be machined. This prevents the saddle peeling device 10 from tilting when machining the surface of a pipe. The handle 51 is provided with a friction-enhancing, rubberized surface that reduces the risk of an operator’s hand slipping off the handle. The handle 51 is attached to the supporting unit 20 by means of a detachable connection. This means that the handle 51 can be replaced quickly if necessary.

The cover 21 of the supporting unit 20 has a shape in the upper section that makes it easier to hold and guide the supporting unit 20 with the second hand of the operator. In the embodiment example of FIG. 1, the cover is rounded outwards in all directions at its edges. The radii of the corresponding roundings differ depending on the orientation of the corresponding edge of the cover. The rounding radius of the edge facing the handle unit 50 is smaller than the rounding radius of the edges facing the axes A₁ and A₂ of the guiding unit 30. A larger rounding radius is provided for the edge facing the handle unit 50. The cover 21 comprises a friction-enhancing surface at least on the upper side, which reduces the risk of an operator’s hand slipping off the cover.

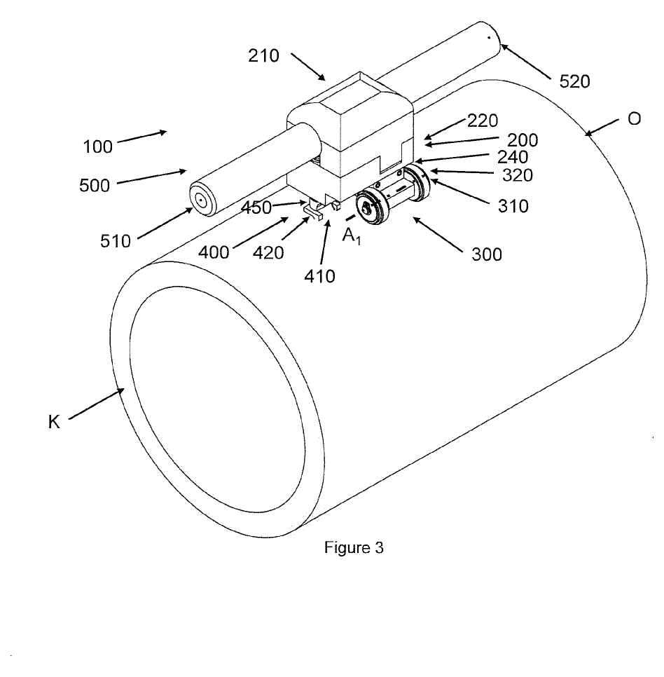

FIGS. 3 and 4 show a second embodiment of the manually operated saddle peeling device 100, wherein the saddle peeling device 100 is exemplarily placed on a surface O of a tube K to be machined. The saddle peeling device 100 shown comprises a supporting unit 200, a guiding unit 300, a peeling unit 400 and a handle unit 500.

The supporting unit 200 comprises a base unit 220 and a cover 210 detachably coupled to the base unit 220.

In the embodiment shown, the guiding unit 300 comprises four rollers or rollers 310 which are arranged on two parallel axes A₁, A₂, (A₂ is not shown in FIG. 3) at a distance from one another. The guiding unit 300 enables the saddle peeling device 100 to be guided at a defined vertical distance from the surface O of the tube K to be machined. The guiding unit 300 is sufficiently rigid so that even a force applied by an operator of the saddle peeling device 100 does not cause the guiding unit 300 to bend between the two parallel axes. The parallel axes are arranged in the peeling direction R in front of the front edge 240 of the supporting unit 200 (axis A₁) and behind the rear edge of the supporting unit 200 (axis A₂), so that the guiding unit 300 extends beyond the supporting unit 200 in the peeling direction R. The vertical distance between the parallel axes A₁, A₂ and the supporting unit 200 is selected such that the rollers 310 attached in each case can rotate freely without contacting the supporting unit 200 when the saddle peeling device 100 is used. The guiding unit 300 is attached to the underside of the supporting unit 200 by means of a screw connection. This allows the guiding unit 300 to be replaced quickly and easily, for example when processing pipes of different diameters, for disassembly for transportation or for maintenance of the guiding unit. The rollers 310 are provided with a running surface 320 which prevents them from slipping on the surface of the tube being machined. The rollers 310 are attached to the respective axles A₁, A₂ by means of snap rings. This allows the rollers 310 to be exchanged for rollers of a different diameter and/or rollers with different running surfaces 320 with little effort.

The peeling unit 400 is attached to an underside of the supporting unit 200, which extends opposite the surface O of the tube K to be machined. The peeling unit 400 is laterally offset with respect to the guiding unit 300. The position of the guiding unit 300 and the peeling unit 400 with regard to the support unit 200 is selected such, that the contact point of the cutting edge of the peeling blade 410 and the surface O of the pipe K to be machined is located at or in peeling direction R slightly behind the apex of the surface O of the pipe K to be machined located in radial direction at a midpoint between the two axis A₁, A₂. The peeling unit 400 extends from the underside of the supporting unit 200 in the direction of the surface O of the tube to be machined. A peeling blade 410, which is held in a peeling blade holder 420, is attached to the lower section of the peeling unit 400. The peeling blade holder 420 is detachably connected to a peeling blade guide 450 via a screw connection. This allows the peeling blade 410 to be replaced quickly. The peeling blade holder 420 comprises a left and a right side sliding block. The sliding blocks is configured to slide or to contact the surface O of a pipe K to be machined with its lower surface. The peeling depth is defined by the inclination of the peeling blade 410 with respect to the peeling direction or the lower sliding surface of the sliding blocks. The peeling blade 410 comprises a portion inclined relative to the surface of the tube to be machined. This section deflects chips that are lifted from the surface during machining upwards, making it easier for them to tear off the surface O of the pipe and to be conveyed away from the peeling blade 410 by the movement of the saddle peeling device 100. The peeling blade guide 450 is substantially designed as a cylinder but comprises a flat surface. The flat surface of the peeling blade guide 450 is directed in a direction opposite to the peeling direction R. A grub screw 470 disposed in the back side of the base unit 220 is used to prevent the peeling blade guide 450 from rotating. The grub screw 470 is secured against loosening by the screw nut 480. The peeling blade guide 450 is accommodated in an adapter 440, which is connected to the base unit 220. By means of a corresponding fit, a play-free connection between the adapter 440 and the peeling blade guide 450 can thus be achieved between the peeling unit 400 and the supporting unit 200. At the same time, a corresponding fit allows vertical adjustment of the peeling blade 410 relative to the surface to be machined. A vertical spring 460 is arranged within the peeling unit 400. As can be seen in FIG. 4, the spring 460 extends through the base unit 220 and is accommodated in an interior space defined by the base unit 220 and the cover 210. The spring 460 applies an adjustable spring force to the peeling blade guide 450. The peeling blade 410 is pressed onto the surface O of the tube K to be machined by means of the spring force acting on it. A pivotable suspension connecting the spring to the peeling blade guide 450 ensure, that the peeling blade 410 is guided parallel to the surface O of the tubular body K to be machined. An indicator on the peeling unit 400 shows the set peeling depth.

A handle unit 500 is attached to the side surfaces of the supporting unit 200. In the embodiment shown, the handle unit 500 comprises two round handles 510 and 520, which enable the saddle peeling device 100 to be guided over a surface O of a tube to be machined. The handles 510, 520 are attached to opposite sides of the supporting unit 200. The two side surfaces of the supporting unit 200 extend parallel to the normal vector of the surface O of the pipe K to be machined. As can be seen in FIG. 4, the attachment point of the handle unit 500, which is defined by the coaxial longitudinal axis of the two handles, is offset or spaced from a vertical central axis M of the supporting unit 200, which extends perpendicular to the coaxial longitudinal axis of the handle unit 500 and parallel to a normal vector of a plane that runs through the two axes of rotation A₁, A₂ of the guiding unit 300, in the opposite direction to the peeling direction R. Furthermore the attachment point of the handle unit 500 is offset against the peeling direction from the contact point of the peeling blade and the surface of the pipe to be machined. This prevents the saddle peeling device 100 from tilting when machining the surface O of a pipe K. The handles 510 and 520 are provided with a friction-enhancing, rubberized surface, which reduces the risk of an operator’s hand slipping off the handle. The length of the handles 510 and 520 is selected so that an operator can grip them with the full width of his hands. The handles 510 are attached to the supporting unit 200 by means of a detachable connection. This means that the handles 510 can be replaced quickly if necessary.

The edges of the cover 210 of the supporting unit 200 are rounded in the upper section in the direction of the axes of the guiding unit 300 and in the direction of the handles 510, 520.

European patent application no. 24180804.7, filed June 7, 2024, to which this application claims priority, is hereby incorporated by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A manually operated saddle peeling device for machining an outer surface of a tubular body, comprising:
a supporting unit;
a guiding unit provided on an underside of the supporting unit and configured to guide the supporting unit in a peeling direction at a defined distance from the surface of the tubular body to be machined;
a peeling unit provided on an underside of the supporting unit opposite the surface of the tubular body to be machined, the peeling unit comprising at least one stationary peeling blade configured to contact the surface of the tubular body to be machined and thereby remove material from the surface of the tubular body; and
a handle unit provided to the side of the supporting unit and generally parallel to the peeling direction and configured to enable manual guidance of the saddle peeling device over the outer surface of the tubular body, at least in portions.

2. The saddle peeling device according to claim 1, wherein the guiding unit comprises two rollers each having axes of rotation arranged in parallel or wherein the guiding unit comprises two rollers each having axes of rotation arranged coaxially.

3. The saddle peeling device according to claim 2, wherein the rollers of the guide device are interchangeable.

4. The saddle peeling device according to claim 1, wherein the guiding unit comprises four rollers, wherein the axes of rotation of at least two rollers are coaxially aligned or wherein the four rollers are arranged on two parallel axes of rotation.

5. The saddle peeling device according to claim 4, wherein the distance between the two axes of rotation is adjustable, and wherein the rollers of the guide device are interchangeable.

6. The saddle peeling device according to claim 4, wherein the peeling unit is coupled to the supporting unit between the two parallel axes of rotation of the guide device, such that the contact point of the peeling blade and the surface of the tubular body to be machined is at or offset against the peeling direction from an intersection of an axis in radial direction defined by the center of the tubular body and a midpoint defined between the two axes of rotation and the surface of the tubular body to be machined.

7. The saddle peeling device according to claim 1, wherein the handle unit includes two handles attached to opposite side surfaces of the supporting unit, wherein the two handles are arranged opposite the supporting unit such that the two handles allow manual guidance of the saddle peeling device parallel to the peeling direction of the peeling blade.

8. The saddle peeling device according to claim 1, wherein the at least one handle unit is mounted at a distance from a vertical central longitudinal axis of the supporting unit.

9. The saddle peeling device according to claim 8, wherein the at least one handle unit is spaced in or against the peeling direction from the vertical central longitudinal axis, such that the mount point of the at least one handle unit, defined by its longitudinal axis is offset in or against the peeling direction from the contact point at which the peeling blade contacts the surface of the tubular body to be machined.

10. The saddle peeling device according to claim 1, wherein the at least one peeling blade of the saddle peeling device is releasably coupled to the saddle peeling device.

11. The saddle peeling device according to claim 1, wherein the vertical distance between the outer surface of the tubular body and the at least one peeling blade of the saddle peeling device is adjustable to vary a cutting depth of the at least one peeling blade.

12. The saddle peeling device according to claim 1, wherein the angle between an axis perpendicular to the cutting edge of the at least one peeling blade of the saddle peeling device and an axis parallel to the peeling direction is adjustable.

13. The saddle peeling device according to claim 1, wherein the angle between an axis perpendicular to the at least one peeling blade of the saddle peeling device and an axis perpendicular to a surface of the tubular body to be machined is adjustable.

14. The saddle peeling device according to claim 1, wherein a spring in a direction perpendicular to the surface of the tubular body to be machined is configured to impress a force on the at least one peeling blade.

15. The saddle peeling device according to claim 14, wherein the force applied to the at least one peeling blade by the spring is adjustable.

16. The saddle peeling device according to claim 1, wherein a spring in a direction parallel to the machining surface of the tubular body is configured to impress a force on the at least one peeling blade.

17. The saddle peeling device according to claim 16, wherein the force applied to the at least one peeling blade by the spring is adjustable.

18. The saddle peeling device according to claim 1, wherein the peeling unit is detachably coupled to the supporting unit.

19. The saddle peeling device according to claim 1, wherein the coupling between the guiding unit and the supporting unit comprises at least one spring, wherein the at least one spring mounted in the connection between the supporting unit and the guiding unit is adjustable.

20. A method of machining a surface of a tubular body, comprising:
exposing a surface of the tubular body to be machined;
adjusting the cutting depth of the peeling blade on a manually operated saddle peeling device according to claim 1;
machining the surface of the tubular body to be machined by manually guiding the saddle peeling device over the surface to be machined.
